(19) United States
(12) Patent Application Publication
(10) Pub. No.: US 2009/0161909 A1
(43) Pub. Date: Jun. 25, 2009

(54) Method of dynamically showing a water mark

(75) Inventors: Su-Woan Chow, Taipei (TW); Ching-San Hsu, Taipei (TW); Chie-Jin Cheng, Taipei (TW); Pong-Sheng Wang, Taipei (TW); Chiung-Yueh Chang, Taipei (TW); Quxiang Fang, Sunnyvale, CA (US)

Correspondence Address: BACON & THOMAS, PLLC, 625 SLATERS LANE, FOURTH FLOOR, ALEXANDRIA, VA, 22314-1176, US

(73) Assignee: NSTREAMS TECHNOLOGIES, INC., Taipei (TW)

(21) Appl. No.: 12/000,951

(22) Filed: Dec. 19, 2007

(51) Int. Cl. G06K 9/00

(52) U.S. Cl. 382/100

(57) ABSTRACT

A method of dynamically showing a water mark is applied in an audio/video transmitter. The audio/video transmitter includes a plurality of display contents such as a playback area name, a playback date, a playback time and an identification mark. The audio/video transmitter continues obtaining a plurality of frames from an audio/video source such as an audio/video server or an audio/video database and temporarily stores the frames in a buffer. The audio/video transmitter also produces a water mark from at least one display content according to a plurality of display conditions such as display coordinates, appearance, time and frequency, and composes the water mark with at least one frame stored in the buffer to form at least one display screen, and shows the display screen on an output unit, such that the water mark on the display screen cannot be changed or overwritten, and viewers can identify the water mark easily.

### FIELD OF THE INVENTION

The present invention relates to a method of showing a water mark, and more particularly to a method of dynamically showing a water mark on a display screen so as to prevent the water mark from easily being overwritten or changed.

### BACKGROUND OF THE INVENTION

As the movie industry is blooming, hundreds of movies are produced each year, and these movies provide consumers various different recreation channels and also satisfy consumers' imaginations. As a result, these movies bring lots of business opportunities and incomes to movie companies and encourage movie companies to invest more in the industry, and movie companies have to invest huge capitals and resources to produce high-quality movies for consumers, and thus the price of a movie ticket remains relatively high due to its high cost. Since a small group of consumers who cannot afford such a high price of a movie ticket, some bad businessmen start engaging in an illegal business of copying unauthorized movies or videotaping a movie in a theater, and selling the unauthorized and unlawful movies at a low price to their target consumers. Such illegal conduct inflicts heavy loss to the movie industry and plagiarizes or infringes the movie creator's intellectual property rights, so that movie companies cannot earn what they deserve.

Hence, movie companies and related manufacturers spare no efforts to raise the level of difficulty for making unauthorized copies, so that unauthorized or unlicensed movies cannot be accessed easily. One of the methods is to install a water mark generator into an audio/video output device, and the water mark generator can display a predetermined identification mark (such as a company logo) at a fixed position (such as the upper right corner) of an output screen, so that unauthorized manufacturers cannot sell the unlawful duplicated movies, and consumers and law enforcers can clearly see the identification mark displayed on the screen of the movies, and consumers can refuse to purchase such unlawful movies thereafter or law enforcers can know the source of unlawful movies and stop unauthorized manufacturers to dispose the unauthorized movies which increase the level of difficulty for unauthorized manufacturers to sell such unauthorized movies.

However, unauthorized manufacturers is able to find a way of breaking through the barrier of water marks, and using a video editing program to change or eliminate the identification mark of the duplicated movies, or overwrite the identification mark disposed at a fixed position by another mark to cover up the unlawful act, so they can sell unauthorized movies in the market. As a result, movie companies are encountering a serious loss of income. Even if law enforcers can track down these unlawful movies, it is very difficult to tell when and where the movies are duplicated without a water mark. It demands immediate attentions and feasible solutions for movie companies to design a method of dynamically showing a water mark to overcome the foregoing shortcomings of the prior art.

### SUMMARY OF THE INVENTION

In view of the social malady and unlawful movie duplication, the inventor of the present invention based on years of experience in the related field to conduct extensive researches and experiments, and finally invented a method of dynamically showing a water mark to stop plagiaries of intellectual property rights and prevent serious losses in the movie industry.

Therefore, it is a primary objective of the present invention to provide a method of dynamically showing a water mark, and the method is applied in an audio/video transmitter. The audio/video transmitter has a plurality of display contents (such as a playback area name, a playback date, a playback time and an identification mark). The audio/video transmitter continues obtaining a plurality of frames from an audio/video source (such as an audio/video server or an audio/video database) and temporarily stores the frames in a buffer. The audio/video transmitter also produces a water mark from at least one display content according to a plurality of display conditions (such as display coordinates, appearance, time and frequency), and composes the water mark with at least one frame stored in the buffer to form at least one display screen. The audio/video transmitter shows the display screen on an output unit, such that the water mark on the display screen cannot be changed or overwritten easily, and viewers can identify the information represented by the water mark.

To make it easier for our examiner to understand the objective, technical characteristics and effects of the present invention, preferred embodiments will be described with accompanying drawings as follows:

### BRIEF DESCRIPTION OF THE DRAWINGS

FIG. 1 is a schematic block diagram of the invention;

FIG. 2 is a flow chart of a preferred embodiment of the invention; and

FIG. 3 is a flow chart of determining a display content of the invention.

### DETAILED DESCRIPTION OF THE PREFERRED EMBODIMENTS

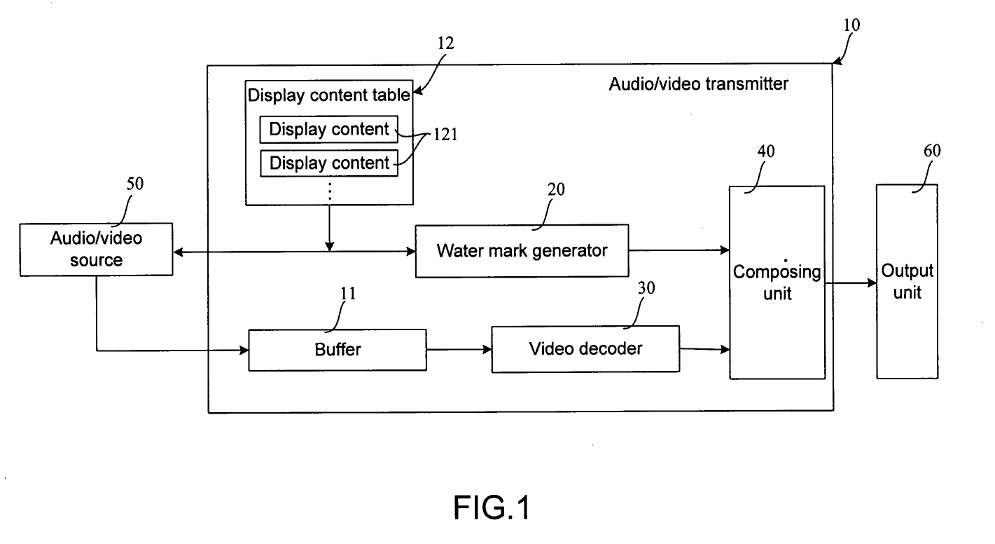

Referring to FIG. 1 for a method of dynamically showing a water mark in accordance with the present invention, the method is applied in an audio/video transmitter 10 (such as a set top box or an in-room communicator), and the audio/video transmitter 10 comprises a water mark generator 20, a video decoder 30 and a composing unit 40 (or an alpha blending engine). The water mark generator 20 is provided for producing a water mark, and the video decoder 30 is provided for processing a frame consisted of a plurality of video signals, and the composing unit 40 is connected to the water mark generator 20 and the video decoder 30 respectively for receiving the water mark generated by the water mark generator 20 and the frame processed by the video decoder 30, and composing the water mark with the frame. When the audio/video transmitter 10 continues obtaining a plurality of frames and audio signals from an audio/video source 50 (such as an audio/video server and an audio/video database) and temporarily stores the frames into a buffer 11, a series of video processing procedures (such as decompression or decoding) is performed for the frames.

The audio/video transmitter 10 has a built-in display content table 12, and the display content table 12 contains a plurality of display contents 121 (such as a playback area name, a playback date, a playback time and an identification mark) displayed on the frame, and the audio/video transmitter 10 randomly sends at least one display content 121 to a water mark generator 20 to produce at least one water mark according to a plurality of display conditions (such as the coordinates, display appearance, time and display frequency of a display content 121), such that the composing unit 40 can compose each water mark with a processed frame on a display screen The audio/video transmitter 10 then displays the display screen on an output unit 60, such that the water mark on the display screen cannot be changed or overwritten, and viewers can identify the information represented by the water mark.

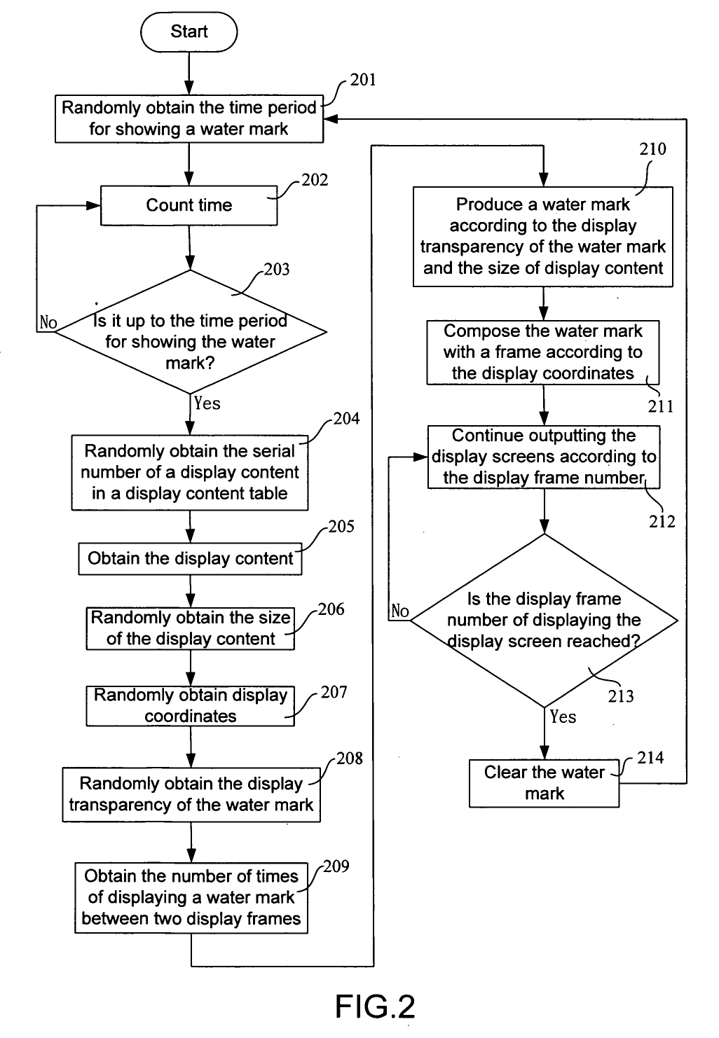

Referring to FIGS. 1 and 2 for a preferred embodiment of the present invention, the audio/video transmitter 10 can be applied in a hotel (or an aircraft), and the audio/video transmitter 10 is used for setting the display contents 121 including a hotel's location, location code, room number, date, time and logo, and for setting the display conditions including display coordinates of a display screen, a display size (such as a font size or a logo size), a display frame number and the time period for showing the next water mark. While the audio/video transmitter 10 is playing the frames and audio signals, a water mark is produced by the procedure comprising the steps of:

Step (201): randomly obtaining the time period for showing the next water mark (in seconds) within a time period range (such as 10˜100 seconds);

Step (202): counting the time period by a timer (not shown in the figure);

Step (203): determining whether or not the timer (not shown in the figure) has reached the time period for showing the next water mark; if yes, then go to Step (204), or else go to Step (202);

Step (204): randomly obtaining a serial number of a display content 121 of a display content table 12 within a first numeric range (such as the number of display contents 121);

Step (205): obtaining the display content 121 according to the serial number in the display content table 12;

Step (206): randomly obtaining the size of the display content 121 within a second numeric range (such as the maximum size of the display content 121);

Step (207): randomly obtaining a group of display coordinates within the coordinates range (such as the resolution of the frame);

Step (208): randomly obtaining a water mark display transparency within a third numeric range (such as the maximum display transparency of the display content);

Step (209): randomly obtaining a display frame number (which is the number of times of displaying a water mark between two display frames) within a fourth numeric range;

Step (210): producing at least one water mark according to the water mark display transparency and the size of the display content 121;

Step (211): composing each water mark onto the frame according to the display coordinates to form a display screen;

Step (212): continuing outputting the display screens onto the output unit 60 according to the display frame number;

Step (213): determining whether or not the display screen has been outputted for the display frame number; if yes, then go to Step (214), or else go to Step (212);

Step (214): clearing the water mark, and going to Step (201).

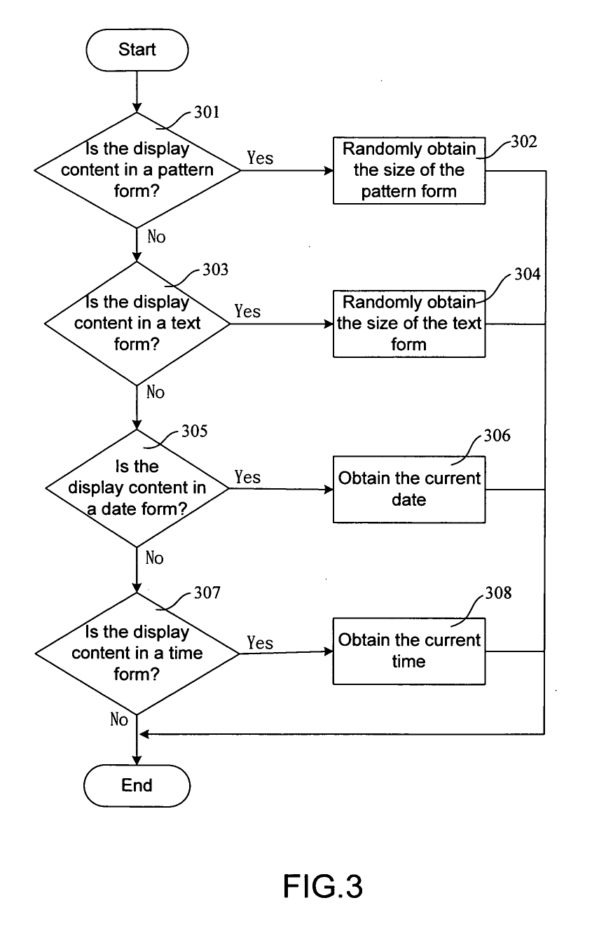

In FIGS. 1 and 3, there are different types of display contents 121. When the audio/video transmitter 10 obtains the display content 121 according to the serial number in the display content table 12, the type of the display content 121 is determined by a procedure comprising the steps of:

Step (301): determining whether or not the display content 121 is in a pattern form (such as a hotel logo); if yes, then go to Step (302), or else go to Step (303);

Step (302): randomly obtaining the size of the pattern form (such as the maximum display size of the hotel logo) within a fifth numeric range, and ending this procedure.

Step (303): determining whether or not the display content 121 is in a text form (such as the hotel name or room number); if yes, then go to Step (304), or else go to Step (305);

Step (304): randomly obtaining the size of the text form (such as the maximum display size of the hotel name or room number) within a sixth numeric range, and ending this procedure.

Step (305): determining whether or not the display content 121 is in a date form (such as a playback date); if yes, then go to Step (306), or else go to Step (307);

Step (306): obtaining the current date, and ending this procedure.

Step (307): determining whether or not the display content 121 is in a time form (such as the current time); if yes, then go to Step (308), or else end this procedure.

Step (308): obtaining the current time.

While the invention herein disclosed has been described by means of specific embodiments, numerous modifications and variations could be made thereto by those skilled in the art without departing from the scope and spirit of the invention set forth in the claims.

What is claimed is:

1. A method of dynamically showing a water mark, applied in an audio/video transmitter, such that when said audio/video transmitter continues obtaining a plurality of frames from an audio/video source, said audio/video transmitter produces at least one water mark from at least one type of display content according to a plurality of display conditions, and composes said each water mark onto at least one frame to form at least one display screen, and said audio/video transmitter displays said each display screen on an output unit.

2. The method of claim 1, wherein said audio/video transmitter creates a plurality of types of display contents, and plays said frame, and said water mark is produced by a procedure comprising the steps of:
randomly obtaining a time period for showing said water mark;
determining whether or not the time period for showing said water mark has reached;
randomly obtaining at least one display content for showing said water mark, when the time period for showing said water mark has reached;
randomly obtaining a display size, display coordinates, a water mark display transparency and a display frame number of said display content;
producing at least one water mark according to said water mark display transparency and said display size;
composing said water mark on said frame to form a display screen according to said display coordinates;
continuing outputting said display screen on said output unit according to said display frame number;
clearing said water mark after the output of said display screen is completed;
returning to the step of randomly obtaining a next water mark display period, and processing the following steps.

3. The method of claim 2, wherein if said audio/video transmitter obtains said display content, a form of said display content is determined by a procedure comprising the steps of:
determining whether or not said display content is in a pattern form; and
randomly obtaining the size of the pattern form, if said display content is in a pattern form.

4. The method of claim 3, wherein if said display content is not in the pattern form, said audio/video transmitter determines whether or not said display content is in a text form; and randomly obtains the size of the text form, if said display content is in a text form.

5. The method of claim 4, wherein if said display content is not in a text form, said audio/video transmitter determines whether or not said display content is in a date form; and obtains the current date, if said display content is in a date form.

6. The method of claim 5, wherein if said display content is not in a date form, said audio/video transmitter determines whether or not said display content is in a time form; and obtains the current time, if said display content is in a time form.
